(19) United States
(12) Patent Application Publication
(10) Pub. No.: US 2007/0132223 A1
(43) Pub. Date: Jun. 14, 2007

(54) Crash structure for an automotive shell structure

(75) Inventor: Matthias Scheffzuek, Tuebingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 10/556,488

(22) PCT Filed: Apr. 15, 2004
(86) PCT No.: PCT/EP04/03962

§ 371 Date: Aug. 7, 2006

(30) Foreign Application Priority Data
May 14, 2003 (DE) 10321573.5

(51) Int. Cl. B62D 21/00

(52) U.S. Cl. 280/784; 180/311

(57) ABSTRACT

An automotive shell structure includes two longitudinal members which are arranged one on each side of the shell structure and are provided with energy-absorbing elements at their front-facing ends. To increase the protection for vehicle occupants in the event of an impact, it is proposed to provide additional energy absorption to channel impact energy into other regions of the shell structure in a controlled manner.

### BACKGROUND AND SUMMARY OF THE INVENTION

This invention relates to an automotive shell structure having a crash structure.

German document DE 198 12 701 A1 discloses an automotive shell structure which has two longitudinal members extending one on each side. An energy-absorbing element is provided at each of the ends of the longitudinal members facing the front in the direction of travel. The energy-absorbing elements are connected to one another by a crossmember. The crossmember is designed as a bumper crossmember. The known arrangement forms an impact plane which faces the front in the direction of travel, this impact plane taking up and, to a certain extent, absorbing forces in the event of an impact and also channeling the forces into the shell, in particular into the longitudinal members, along designated force paths.

Furthermore, German document DE 100 36 396 A1 discloses an automotive shell structure having longitudinal members extending on both sides, in which structure a subframe module is arranged at the ends of the longitudinal members facing the front in the direction of travel. The subframe module forms a continuation of the longitudinal members at the ends facing the front in the direction of travel and connects them to one another in the transverse direction of the vehicle. Arranged in front of the subframe module, in turn, is an energy absorption element which takes up and, to a certain extent, absorbs force in the event of an impact and also channels the force into the shell, in particular into the longitudinal members, along designated force paths.

The arrangements disclosed in the prior art are therefore notable for the fact that the force is substantially taken up by the main longitudinal members during an impact.

Against this background, the object on which the present invention is based is to provide an automotive shell structure which improves the safety of vehicle occupants in the event of an impact.

This object is achieved according to the invention by an automotive shell structure as claimed.

The automotive shell structure according to the invention is notable for the fact that, in addition to an energy-absorbing arrangement assigned to the two main longitudinal members, there are provided further energy-absorbing means which enable impact energy to be channeled into other regions of the shell structure. Where mention is made in conjunction with the invention of other regions of the shell structure, this means those regions of the shell structure which are situated outside the plane containing the main longitudinal members. Consequently, an additional force path for energy absorption is activated. The effect of this is that more energy can be absorbed by the shell structure, thereby preventing intrusion into the vehicle passenger compartment.

It is conceivable for the means for energy absorption to be arranged on an integral support which extends between the longitudinal members and serves for mounting wheel suspension elements. Just like the longitudinal members, the integral support constitutes a part of the shell structure which is stable and suited for energy absorption. This is all the more true if the support has connecting elements extending in the transverse direction of the vehicle.

The additional means for energy absorption may be designed as a crash box. In conjunction with the invention a crash box refers to a component whose shape, structural design and material make it particularly suitable for absorbing energy. Such a crash box may, for example, be constructed from steel, aluminum or plastic. It is conceivable to produce the crash box from an extruded aluminum profile. It may, for example, act on the concertina or rolling flexion principle or, as is particularly possible in the case of plastics, on the destruction principle. In all of the stated principles, energy is absorbed to a high degree during the deformation or the destruction. In addition, the crash box may have specifically arranged beads which influence the deformation behavior of the crash box in a defined manner. The crash box may be of either a single-part or multipart construction.

Such a crash box may, for example, be provided on each side of the end of the integral support facing the front in the direction of travel. In this way the automotive shell structure would be aligned by way of two additional energy-absorbing means. The arrangement on each side of the integral support is accompanied by the advantage that the automotive shell structure is afforded a symmetrical configuration which ensures that the impact energy is channeled into the structure in a uniform manner, counteracting the occurrence of stress peaks.

The integral support may have mounting sockets for the crash boxes. These mounting sockets may, for example, have their shape adapted to the shape of the crash boxes, with the result that the latter are received by the integral support in a form-fitting manner. It is also conceivable for a detachable connection to be produced between the crash box and the integral support, for example by a screw fitting. Such a connection is accompanied by the advantage that the crash boxes may be exchanged in a simple manner depending on the strength of the impact, which increases the repairability of the automotive shell structure. Of course, it is also conceivable to produce a nondetachable connection, for example by welding.

The mounting sockets or fastening points on the integral support may be of particularly rigid construction, thereby ensuring a secure connection between the crash box and integral support. This connection is accompanied by the advantage that the impact force which is channeled into the integral support crash boxes during an impact is reliably channeled into the integral support.

According to a further embodiment, the crash boxes may be connected to one another via a crossmember. The crossmember makes it possible to achieve wide-area energy absorption which is independent of the orientation of the impact force channeled in due to the impact.

The crossmember may be of multipart design and comprise a right and left crossmember part. It is conceivable here for each of the two crossmember parts to have one end connected to the integral support and the other end connected to the crash box. The connection of the crossmember parts to the integral support may be made at the center of the integral support between the two crash boxes. If the two crossmember parts are additionally arranged in the form of a crank lever, the forces are in each case channeled into the crash box in the longitudinal direction of the vehicle as a result of the lever action, independently of the channeling-in direction of the impact force. This causes a deformation of the crash box in the longitudinal direction of the vehicle and thus results in maximum energy absorption. In other words, the energy absorption is increased by virtue of a deformation or destruction of the crash box being possible without buckling. This mode of action may be improved by optimized orientation of the crash box with respect to the crossmember parts.

Both the crash crossmember and the crash box absorb additional energy, thereby increasing the energy absorption overall. In addition to the plane containing the main longitudinal members, they also open up an additional force path in the automotive shell structure, as a result of which further energy is absorbed.

The invention will be explained in more detail below with the aid of the exemplary embodiments represented in the drawings.

### BRIEF DESCRIPTION OF THE DRAWINGS

FIG. 1 shows a side view of an automotive shell structure with a plane containing the main longitudinal members and with an integral support;

FIG. 2 shows a three-dimensional view of an integral support with crash boxes according to the invention;

FIG. 3 shows a three-dimensional view of an integral support with crash boxes according to the invention and also crossmember parts, and

FIG. 4 shows a plan view of the integral support according to FIG. 3.

### DETAILED DESCRIPTION OF THE INVENTION

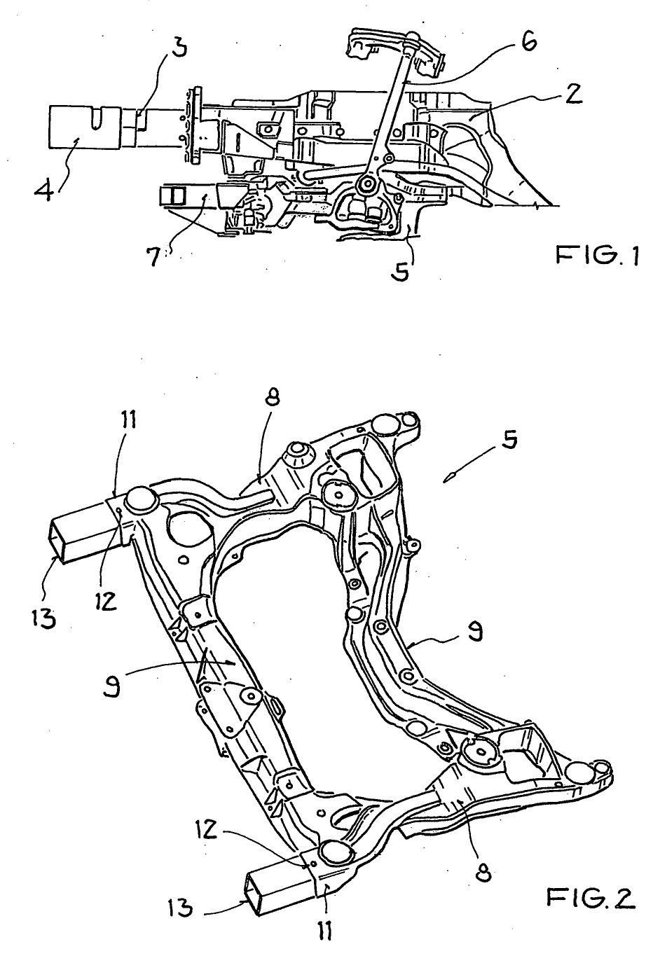

FIG. 1 represents the front region of an automotive shell structure. A main longitudinal member 2 extends transversely in the illustration, a crash box 3 adjoining its end facing the front in the direction of travel (on the left-hand side here). There are two such main longitudinal members 2 provided in a car and they are arranged on each side of the shell structure. The crash box 3 is connected to a front end, which is provided for example with a crossmember 4. An integral support 5 is arranged below the main longitudinal member 2. The integral support 5 extends between the two main longitudinal members 2 and serves, inter alia, for mounting wheel suspension elements (not shown). The front axle 6 can also be seen in FIG. 1. The crash structure 7 according to the invention adjoins the end of the integral support 5 facing the front and is explained in more detail in conjunction with the figures below.

FIG. 2 is a three-dimensional illustration of the integral support 5. The support substantially comprises two members 8 extending in the longitudinal direction of the vehicle and also two connecting members 9 which extend in the transverse direction of the vehicle and connect the members 8 to one another. The members 8 and the connecting members 9 form a rectangle.

Mounting sockets 11 are provided as an extension of the members 8 at the end of the integral support 5 facing the front in the direction of travel. The mounting sockets 11 are each provided at the outermost end of the integral support 5. The mounting sockets 11 have a rectangular cross section. Drilled holes 12 for fastening elements, such as screws or rivets, are additionally provided in the mounting sockets 11.

Crash boxes 13 are arranged in each of the mounting sockets 11 and can be connected to the integral support 5 through the drilled holes 12 by suitable connecting elements. The cross section of the crash boxes 13 is likewise rectangular, with the result that the crash boxes 13 are received by the mounting sockets 11 in a form-fitting manner. This form-fitting mounting promotes reliable propagation of forces from the crash boxes 13 to the integral support 5.

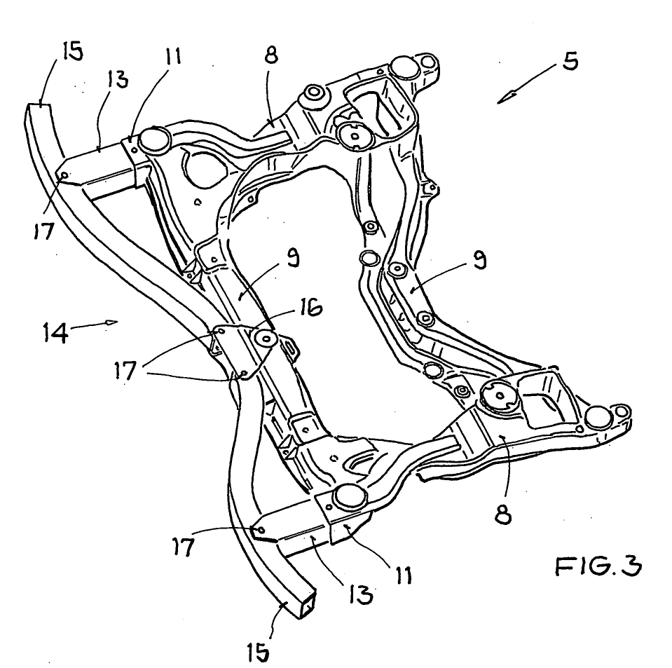

FIG. 3 again shows an integral support 5 with two members 8 and two connecting members 9 in a perspective illustration. In addition to the exemplary embodiment described in conjunction with FIG. 2, the integral support represented in FIG. 3 has a crossmember arrangement 14. The crossmember arrangement 14 has two crossmember parts 15. The crossmember parts 15 extend substantially parallel to the front connecting member 9, with one crossmember part 15 being arranged on the right-hand side of the integral support as viewed in the direction of travel and one crossmember part 15 being arranged on the left-hand side of the integral support as viewed in the direction of travel.

The crossmember parts 15 are designed to be approximately S-shaped. The end of the crossmember parts 15 facing the center is connected to the connecting member 9 of the integral support 5 via a mount 16. By contrast, the outwardly facing end of the crossmember parts 15 is connected to a respective crash box 13. In the exemplary embodiment represented the crossmember parts 15 are connected to the mount 16 via a screw fitting. The same applies to the connection between the crossmember part 15 and the crash box 13. For this purpose, both the mount 16 and the crash box 13 have specially designed seats with drilled holes 17 for receiving the connecting elements. The crossmember parts are constructed in such a way that they extend outwardly beyond the crash boxes 13, with the result that the crossmember arrangement 14 overall is wider than the integral support 5. The S-shaped design of the crossmember parts 15 has the effect that the crossmember arrangement 14 extends very close to the integral support 5 at the center and, moving outwardly, the spacing between the integral support 5 and the crossmember arrangement 14 becomes continuously larger until the spacing has grown to the length of the crash box 13. The end of the crossmember parts 15 extending beyond the crash boxes and directed toward the integral support 5 is bent slightly further back again.

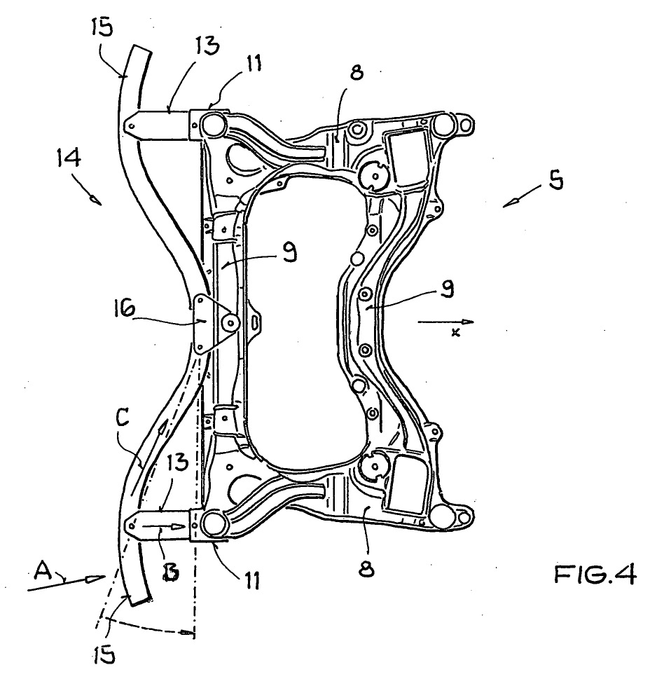

The text below gives a more detailed explanation of the mode of action of the crossmember arrangement 14 in conjunction with the crash boxes 13 in the event of an impact. The design of the crossmember parts 15 as crank levers has the effect that the crash box 13 is always loaded substantially in the longitudinal direction of the vehicle, independently of the direction of the impact force channeled in during an impact. Any transverse forces which occur are absorbed directly by the integral support 5 as a result of the crossmember parts being supported thereon by way of the mount 16. This principle of action is represented in FIG. 4. If an impact force is channeled obliquely into the structure according to the invention as indicated by the arrow A, the impact force component acting in the longitudinal direction is propagated into the integral support 5 via the crash box 13 (cf. arrow B). By contrast, the forces acting in the transverse direction are, as indicated by the arrow C, channeled via the crossmember part 15 in the direction of the mount 16 and, via the latter, into the integral support 5. Consequently, the crash box 13 is always subjected to stress substantially in the longitudinal direction of the vehicle. This prevents the crash box 13 from buckling during loading, thereby ensuring that a maximum quantity of energy is always absorbed.

1-11. (canceled)

12. An automotive shell structure arrangement comprising:
substantially parallel longitudinal members arranged on each side of a shell structure,
energy-absorbing elements which, in an impact, absorb impact energy and also channel impact energy into the longitudinal members, provided on ends of the longitudinal members which face front in the direction of travel, and
additional means for energy absorption adapted to channel the impact energy into other regions of the shell structure in a controlled manner.

13. The automotive shell structure arrangement as claimed in claim 12, wherein an integral support extends between the longitudinal members.

14. The automotive shell structure arrangement as claimed in claim 12, wherein the additional means for energy absorption are arranged at an end of the integral support facing the front in the direction of travel.

15. The automotive shell structure arrangement as claimed in claim 14, wherein the additional means for energy absorption are designed as crash boxes.

16. The automotive shell structure arrangement as claimed in claim 15, wherein one of said crash boxes is provided on each side of the end of the integral support facing the front in the direction of travel.

17. The automotive shell structure arrangement as claimed in claim 15, wherein the integral support has mounting sockets with shapes adapted to the shape of the crash boxes.

18. The automotive shell structure arrangement as claimed in claim 15, wherein the crash boxes are connected to one another via a crossmember.

19. The automotive shell structure arrangement as claimed in claim 18, wherein the crossmember is of multipart design.

20. The automotive shell structure arrangement as claimed in claim 19, wherein the crossmember comprises right and left crossmember parts, and wherein each of the crossmember parts has one end connected to the crash box and another end connected to the integral support.

21. The automotive shell structure arrangement as claimed in claim 20, wherein the crossmember parts are connected centrally between the crash boxes to the integral support.

22. The automotive shell structure arrangement as claimed in claim 18, wherein the crossmember is constructed in such a way that, by way of a lever arrangement, an impact force is channeled into the crash boxes substantially in a longitudinal direction of the vehicle.

23. The automotive shell structure arrangement as claimed in claim 13, wherein the additional means for energy absorption are arranged at an end of the integral support facing the front in the direction of travel.

24. The automotive shell structure arrangement as claimed in claim 16, wherein the integral support has mounting sockets with shapes adapted to the shape of the crash boxes.

25. The automotive shell structure arrangement as claimed in claim 16, wherein the crash boxes are connected to one another via a crossmember.

26. The automotive shell structure arrangement as claimed in claim 17, wherein the crash boxes are connected to one another via a crossmember.

27. The automotive shell structure arrangement as claimed in claim 19, wherein the crossmember is constructed in such a way that, by way of a lever arrangement, an impact force is channeled into the crash boxes substantially in a longitudinal direction of the vehicle.

28. The automotive shell structure arrangement as claimed in claim 20, wherein the crossmember is constructed in such a way that, by way of a lever arrangement, an impact force is channeled into the crash boxes substantially in a longitudinal direction of the vehicle.

29. The automotive shell structure arrangement as claimed in claim 23, wherein the additional means for energy absorption are designed as crash boxes.

30. The automotive shell structure arrangement as claimed in claim 29, wherein one of said crash boxes is provided on each side of the end of the integral support facing the front in the direction of travel.

31. The automotive shell structure arrangement as claimed in claim 24, wherein the crash boxes are connected to one another via a crossmember.
